(19) United States
(12) Patent Application Publication
(10) Pub. No.: US 2025/0127151 A1
(43) Pub. Date: Apr. 24, 2025

(54) DECORATED ARTICLE AND FISHING ROD

(71) Applicant: Shimano Inc., Osaka (JP)

(72) Inventor: Daisuke YAMANAKA, Osaka (JP)

(21) Appl. No.: 18/921,682

(22) Filed: Oct. 21, 2024

(30) Foreign Application Priority Data
Oct. 23, 2023 (JP) 2023-181722

(51) Int. Cl. A01K 87/00; B05D 5/06

(52) U.S. Cl. CPC A01K 87/00; B05D 5/068

(57) ABSTRACT

A decorated article includes a substrate, a decorative layer and a base layer. The decorative layer contains a particle component. The base layer is disposed between the substrate and the decorative layer, and the base layer has a covered portion covered by the decorative layer and a peripheral portion disposed on a peripheral edge of the covered portion.

### CROSS-REFERENCE TO RELATED APPLICATIONS

This application claims priority to Japanese Patent Application No. 2023-181722, filed on Oct. 23, 2023. The entire disclosure of Japanese Patent Application No. 2023-181722 are hereby incorporated by reference.

### BACKGROUND

### Technical Field

The present disclosure relates to an article and/or a fishing rod having a decorated surface.

### Background Information

Japanese Laid Open Patent Application No. 2017-202592 discloses a surface of a fishing rod that is decorated. Specifically, as an example of conventional decoration, a configuration has been disclosed in which a metal reflective layer 201 covers the entire surface of a UV printed layer 200, as shown in FIG. 5.

### SUMMARY

However, it has been determined that there is a demand to depict the outlines of decorations more sharply.

Accordingly, an object of the present disclosure is to achieve higher precision in the depictions of decorations.

In a first aspect according to the present disclosure, a decorated article comprises a substrate, a decorative layer, and a base layer. The decorative layer contains a particle component. The base layer is provided between the substrate and the decorative layer. The base layer has a covered portion and a peripheral portion. The covered portion is covered by the decorative layer. The peripheral portion is provided on the peripheral edge of the covered portion.

According to this configuration, the peripheral portion of the base layer is not covered by the decorative layer and protrudes outward from the decorative layer. As a result, the outer edge of the decorative layer is less likely to be affected by the outer edge, i.e., the outline, of the base layer, thereby facilitating formation of the outer edge of the decorative layer with high precision.

In a second aspect of a decorated article according to the first aspect of the present disclosure, the decorative layer contains a volatile ink component. As can be understood, volatile ink component has high flowability. As a result, the volatile ink component spreads around smoothly when the decorative layer is formed. Accordingly, finely depicting the outer edge of the decorative layer is easy.

In a third aspect of a decorated article according to the first or second aspect of the present disclosure, the particle component contains metal particles. According to this configuration, a decorative layer with high brightness is obtained, with excellent aesthetic appeal.

In a fourth aspect of a decorated article according to the third aspect of the present disclosure, the metal particles contain a silver particle component. According to this configuration, a decorative layer having high brightness can be easily obtained.

In a fifth aspect of a decorated article according to any one of the first to the fourth aspects of the present disclosure, the maximum thickness of the decorative layer is 20 nm or more and 80 nm or less. According to this configuration, since the thickness of the decorative layer is small, it is possible to finely depict the outer edge of the decorative layer, enhancing the decorativeness.

In a sixth aspect of a decorated article according to any one of the first to the

fifth aspects of the present disclosure, the thickness of the base layer is thicker than that of the decorative layer. According to this configuration, it is possible to obtain a three-dimensional decoration.

In a seventh aspect of a decorated article according to any one of the first to the sixth aspects of the present disclosure, the maximum thickness of the base layer is 80 μm or more and 150 μm or less. According to this configuration, it is possible to obtain a three-dimensional decoration.

In an eighth aspect of a decorated article according to any one of the first to the seventh aspects of the present disclosure, the maximum thickness of the covered portion is greater than the maximum thickness of the peripheral portion. According to this configuration, it is possible to obtain a three-dimensional decoration.

In a ninth aspect of a decorated article according to any one of the first to the eighth aspects of the present disclosure, the base layer contains a UV-curable resin. According to this configuration, the base layer can be easily cured, facilitating the creation of the decoration.

In a tenth aspect of a decorated article according to the ninth aspect of the present disclosure, the surface of the base layer is leveled so that edges are not present. According to this configuration, the outer edge of the decorative layer is smooth, resulting in an improved appearance.

In an eleventh aspect of a decorated article according to the ninth or tenth aspects of the present disclosure, the surface of the peripheral portion is leveled so that edges are not present. According to this configuration, the outer edge of the base layer is smooth. Therefore, even if the outer edge of the decorative layer is affected by the outer edge of the base layer, the outer edge of the decorative layer is less likely to be disturbed, resulting in a smooth outer edge of the decorative layer.

In addition, a fishing rod according to the present disclosure comprises a rod body and a three-dimensional decorate portion. The rod body is made of a substrate according to any one of the first to the eleventh aspects described above. The three-dimensional decorate portion is provided on the rod body. The three-dimensional decorate portion has a three-dimensional portion and a decorate portion. The three-dimensional portion is provided on the rod body. The three-dimensional portion is composed of a base layer according to any one of the first to the eleventh aspects described above. The decorate portion is provided in a part of the three-dimensional portion. The decorate portion is composed of a decorative layer according to any one of the first to the eleventh aspects described above.

According to this configuration, a fishing rod having excellent decorativeness can be obtained.

As described above, since the peripheral edge of the base layer protrudes outward from the decorative layer, it is possible to form the outline of the decorative layer to be sharp, which increases the precision of the decoration and improves the decorativeness of the article.

### BRIEF DESCRIPTION OF THE DRAWINGS

FIG. 1 is a plan view of a main portion of a fishing rod with a decorated article according to one embodiment of the present disclosure.

FIG. 2 is an enlarged view of part P in FIG. 1.

FIG. 3 is a cross-section diagram along the A-A line in FIG. 2.

FIG. 4 is a schematic perspective view showing one example of an inkjet printer.

FIG. 5 is a cross-sectional view of a main part of a conventional decorated article.

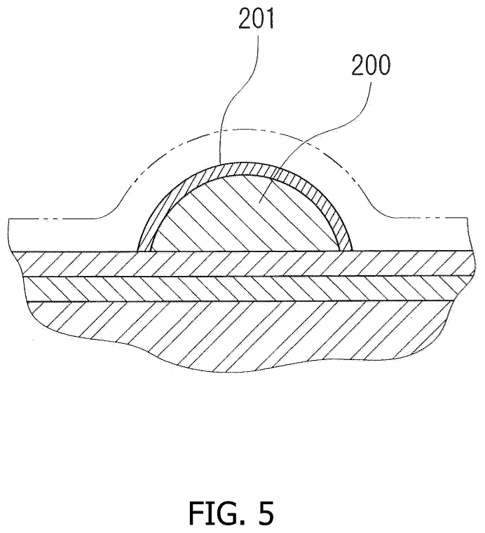

### DETAILED DESCRIPTION

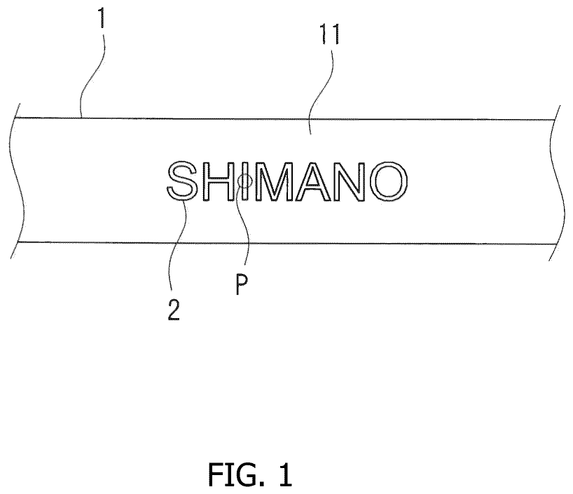

A fishing reel 100 according to one embodiment of the present disclosure is a dual-bearing reel. As shown in FIGS. 1 to 4, the fishing reel 100 comprises a reel body 1, a handle 2, a spool 3, a braking device (brake) 4, a control device (controller) 5, a first operating member (first operator) 6, and a second operating member (second operator) 7.

A decorated article according to one embodiment of the present disclosure will be described below, with reference to the drawings. The decorated article (article) in the present embodiment is a fishing rod. The article is not limited to a fishing rod and can be a device used for various purposes, for example, fishing equipment other than a fishing rod, such as a reel, a bicycle part, or the like.

FIG. 1 shows the main part of the fishing rod according to the present embodiment. The fishing rod comprises a rod body 1 (one e.g., a “substrate”) and a three-dimensional decorate portion 2. The rod body 1 is a so-called blank, and is preferably made of fiber-reinforced resin. The reinforcing fiber is, for example, carbon fiber. The rod body 1 can be hollow or solid. In one embodiment, the rod body 1 is a substrate.

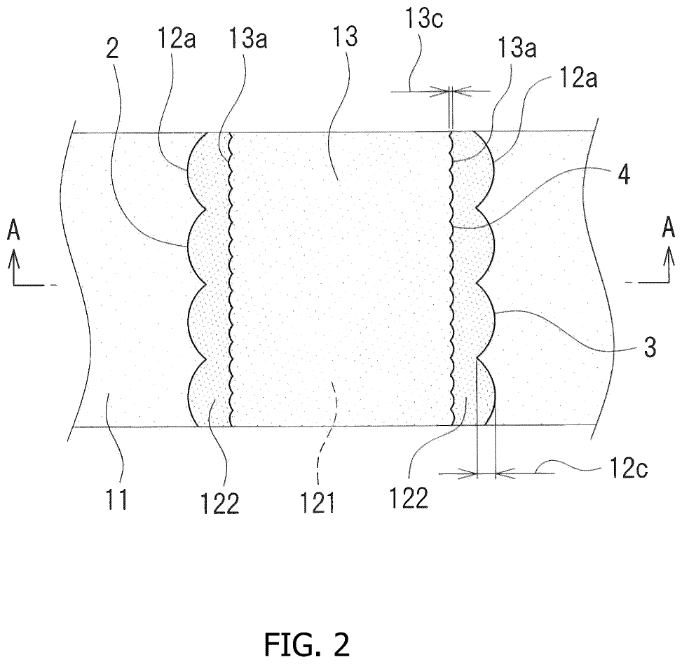

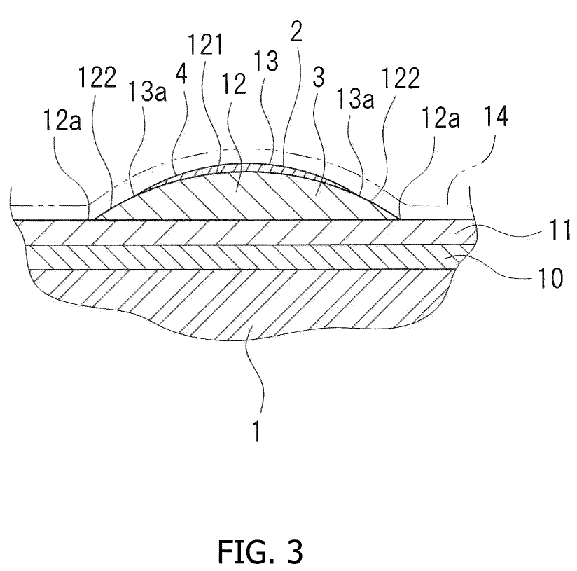

The three-dimensional decorate portion 2 is disposed on the surface of the rod body 1. In the present embodiment, the three-dimensional decorate portion 2 is disposed only on a part of the circumference of the rod body 1, but can be provided over the entire circumference. Details of the three-dimensional decorate portion 2 are shown in FIGS. 2 and 3. The three-dimensional decorate portion 2 has a three-dimensional portion 3 (e.g., a “base layer”) and a decorate portion 4 (e.g., a “decorative layer”). The surface of the three-dimensional decorate portion 2 is a curved surface, such as a hemispherical surface, a dome shape, or a tunnel shape.

In the present embodiment, the surface of the rod body 1 includes, in order from the radially inner side of the rod body 1, a first underlayer 10, a second underlayer 11, and the three-dimensional decorate portion 2. In the three-dimensional decorate portion 2, the three-dimensional portion 3 is composed of a base layer 12, and the decorate portion 4 is composed of a decorative layer 13. The present embodiment includes the first underlayer 10 and the second underlayer 11, but the three-dimensional decorate portion 2 can be disposed directly on the surface of the rod body 1 serving as a substrate, without including any underlayers. In addition, as shown by the chain double-dashed line in FIG. 3, in the present embodiment, the surfaces of the second underlayer 11 and the three-dimensional portion 3 (base layer 12, decorative layer 13) include a topcoat layer 14 as a protective layer, but it is also possible to omit the topcoat layer 14. Furthermore, a coating layer, an adhesive layer, etc., can be provided between each of the first underlayer 10, the second underlayer 11, the three-dimensional decorate portion 2, and the topcoat layer 14.

The first underlayer 10 is preferably provided over the entire circumference of the surface of the rod body 1. The thickness of the first underlayer 10 can be constant. The first underlayer 10 can be colored or colorless, and can be transparent or opaque. The first underlayer 10 is composed of various types of paint, which may be acrylic urethane, acrylic melamine, epoxy-based paint, ester-based paint, and the like. In the present embodiment, the first underlayer 10 is composed of various types of paint, but the first underlayer 10 can be formed by attaching a laminate sheet, or the like.

The second underlayer 11 is disposed on the surface of the first underlayer 10. The second underlayer 11 can constitute a first pattern. The first pattern can be various designs or characters. The three-dimensional decorate portion 2 described above constitutes a second pattern that is different from the first pattern. The thickness of the second underlayer 11 can be constant. The second underlayer 11 is disposed within an area in which the first underlayer 10 is formed. The second underlayer 11 is stacked on the surface of the first underlayer 10, the first underlayer 10 serving as an underlayer. The area in which the second underlayer 11 is formed is within the area in which the first underlayer 10 is formed. Therefore, the formation area of the second underlayer 11 is smaller than the formation area of the first underlayer 10. The second underlayer 11 covers all or part of the first underlayer 10. The second underlayer 11 can be disposed in one location, or disposed in a plurality of locations. In addition, the second underlayer 11 can include a cutout pattern portion, which is a non-printed portion. The cutout pattern portion can be a character or a figure, and can be disposed in one or more locations on one second underlayer 11.

In the present embodiment, the second underlayer 11 is composed of a one-component type ink containing blocked isocyanate. In particular, the one-component type ink can be an inkjet ink. The second underlayer 11 can be formed by an inkjet printing device. The one-component type ink contains a base compound and a curing agent. The base compound is a compound having active hydrogen, and the curing agent is an isocyanate compound. The one-component type ink is a block type ink, having blocked isocyanate in which isocyanate is masked with a blocking agent. When blocked isocyanate is heated, the blocking agent is dissociated, and the isocyanate group is regenerated. The blocking agent can be dissociated by light instead of heat.

The one-component type ink may be a one-component type polyurethane resin paint, consisting of blocked isocyanate and polyol. Blocked isocyanate is obtained by reacting various types of blocking agents with various types of isocyanate compounds. The isocyanate compound, which is the raw material used for the blocked isocyanate, can be of various types, such as methylene diphenyl diisocyanate (MDI), methyl isocyanate (MIC), hexamethylene diisocyanate (HDI), toluene diisocyanate (TDI), isophorone diisocyanate (IPDI), etc.

The blocking agent can be of various types, such as alocohols, ϵ-caprolactam, phenols, oximes, active methylene compounds, and the like. The polyol can be of various types, such as acrylic polyol, polyester polyol, polycarbonate polyol, or the like.

The one-component type ink contains a solvent, a dye or pigment, and a dispersant. In addition to the blocked isocyanate, various types of isocyanates that are not masked with a blocking agent may be contained. However, when unmasked isocyanate is contained, the amount of said isocyanate should be less than the blocked isocyanate. In the present embodiment, the second underlayer 11 is formed of inkjet ink by inkjet printing, but the second underlayer 11 can be formed by attaching a laminate sheet, or the like, in the same manner as the first underlayer 10.

In the present embodiment, the three-dimensional decorate portion 2 is disposed on the surface of the second underlayer 11. Specifically, the base layer 12 of the three-dimensional decorate portion 2 is provided within the formation area of the second underlayer 11, and covers at least a portion of the second underlayer 11. The base layer 12 is transparent, and may be either colorless transparent or colored transparent. The surface of the base layer 12 is a curved surface, such as a hemispherical surface, a dome shape, or a tunnel shape.

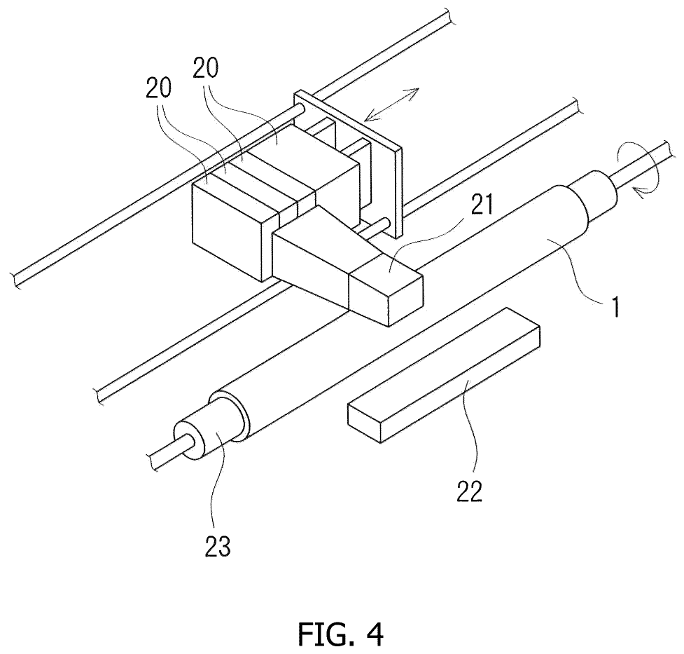

The base layer 12 can be formed using an inkjet printer, such as that shown in FIG. 4. The inkjet printer is equipped with a tank 20 that stores ink paint, and a head 21 that applies ink paint supplied from the tank 20 to an object. The basic color inks are cyan, magenta, yellow, and black inks. However, white, silver, etc., inks may also be used as needed. A plurality of discharge nozzles that supply the cyan, magenta, yellow, and black inks in the form of droplets are arranged in the head 20. Each discharge nozzle includes a plurality of ejection holes. In addition, the inkjet printer includes a heating medium. The heating medium receives operation information from a control means or controller (not shown) and rapidly heats the ink to promote formation of droplets, which are then ejected by air bubbles. This method is called the thermal jet method. However, a piezoelectric method can be employed instead. Furthermore, the inkjet printer includes a UV irradiation device 22. The rod body 1 is mounted on a mandrel 23. By rotating the mandrel 23 around the axis thereof, the rod body 1 is rotated together with the mandrel 23. Then, the head 21 is moved along the axis of the mandrel 23. The coating can be applied in accordance with the multi-pass method. In the multi-pass method, the head applies coating, not in a single pass, but by moving over the same spot multiple times. The number of passes can be any given number.

UV ink droplets are discharged from the discharge nozzle, which are irradiated with ultraviolet rays from the UV irradiation device 22, thereby curing and fixing the ink. The viscosity of this UV ink, the time between the adhesion of the discharged ink droplets and the irradiation of the ultraviolet rays, and the amount of ultraviolet light can be adjusted to adjust the height, spread, and shape of the base layer 12. At this time, since the UV ink droplets are discharged, the edges are formed of consecutive circles, such as shown by a first outer edge 12a and a second outer edge 13a in FIG. 2, resulting in an outline that is not sharp. Note that FIG. 2 is an exaggerated illustration and differs somewhat from reality. The UV ink can be of a photopolymerization type, containing resin that is cured by ultraviolet rays. The UV-curable resin may be any of various radical polymerization resins, and be any of various oligomers or monomers. Examples of oligomers include epoxy acrylate, urethane acrylate, and polyether acrylate. The photopolymerization initiator can be of various types, such as a benzophenone-based, a benzoin-based, an acetophenone-based, a thioxanthone-based, or an acylphosphine oxide-based photopolymerization initiator. Note that, in addition to the photopolymerizable oligomers, etc., and the photopolymerization initiator, the UV ink also contains an antifoaming agent, and the like.

As shown in FIG. 2, the base layer 12 is divided into two portions, a covered portion 121 and a peripheral portion 122. The covered portion 121 is a portion covered by the decorative layer 13. The peripheral portion 122 is a portion not covered by the decorative layer 13, and that is disposed on the peripheral edge of the covered portion 121, corresponding to the peripheral portion of the base layer 12. Only the covered portion 121 of the base layer 12 is covered by the decorative layer 13. The decorative layer 13 is formed in an area smaller than the base layer 12. The covered portion 121 is entirely covered by the decorative layer 13. The peripheral portion 122 is the portion protruding outward from the decorative layer 13. The peripheral portion 122 is the area between the second outer edge 13a of the decorative layer 13 and the first outer edge 12a of the base layer 12, and is defined by the second outer edge 13a of the decorative layer 13 and the first outer edge 12a of the base layer 12. The peripheral portion 122 is formed around the covered portion 121. The peripheral portion 122 is a border portion that borders the decorative layer 13. The outer edge of the peripheral portion 122 is the first outer edge 12a of the base layer 12.

Since the UV ink droplets are discharged from the inkjet printer, the thickness of the base layer 12 is not constant, as shown in FIG. 3. The thickness of the covered portion 121 is thicker than the thickness of the peripheral portion 122. The base layer 12 has a convex shape that protrudes radially outward of the rod body 1. The thickness of the base layer 12 gradually increases from the first outer edge 12a to the covered portion 121, that is, from the peripheral portion 122 side to the covered portion 121 side. The thickness of the base layer 12 is greatest at the central portion thereof, and gradually decreases therefrom toward the first outer edge 12a. The thickness of the base layer 12 is smallest at the first outer edge 12a. In general, the maximum thickness of the base layer 12 is preferably 80 μm or more and 150 μm or less, which provides a three-dimensional effect. However, it is possible that the maximum thickness could exceed 150 μm and be about 300 μm, when graphic printing or other techniques are used to create a three-dimensional display. The maximum thickness of the covered portion 121 is the maximum thickness of the base layer 12. The maximum thickness of the covered portion 121 is greater than the maximum thickness of the peripheral portion 122. The maximum thickness of the peripheral portion 122 is the same as the minimum thickness of the covered portion 121. The maximum thickness of the base layer 12 is greater than the thickness of the second underlayer 11. The base layer 12 can be disposed on a grip portion of the rod body 1, in which case the convex shape of the base layer 12 provides good decorativeness and grip.

The surface of the base layer 12 is leveled so that edges are not present. That is, a certain amount of time (time for leveling) can be provided for the UV ink droplets to settle after the droplets land, to obtain gloss. The surface of the peripheral portion 122 can be configured such that no edges are present by leveling. The thickness of the base layer 12 can be formed by printing multiple coats using an inkjet printing device. By applying multiple coats, the thickness can be adjusted to any thickness. It is possible to adjust the maximum thickness of the base layer 12 to preferably 80 μm or more and 150 μm or less. When forming the base layer 12 using the inkjet printer described above, for example, the head 21 of the inkjet printer is scanned along the central axis direction of the rod body 1, as the rod body 1 is rotated around the central axis thereof. A prescribed pattern can be printed using the inkjet printer, after which the pattern can be cured by irradiating ultraviolet rays using the UV irradiation device 22 to easily form the base layer 12. In this manner, by forming the base layer 12 using an inkjet printer, the surface of the base layer 12 is leveled, resulting in a smooth surface without edges and in a convex shape having a thickness of 80 μm or more and 150 μm or less.

As shown in FIG. 2, a first corrugated portion 12b that undulates in the inward/outward directions is formed on the first outer edge 12a of the base layer 12 (outer edge of the peripheral portion 122). The first corrugated portion 12b is provided continuously along the first outer edge 12a of the base layer 12 (outline of the base layer 12). The first corrugated portion 12b is formed by ink droplets that form the base layer 12. The first corrugated portion 12b has a first undulation amount 12c, which is the amount of undulation in the inward/outward direction. The first undulation amount 12c indicates the degree of jaggedness of the first outer edge 12a. The first corrugated portion 12b can be provided regularly or irregularly along the first outer edge 12a of the base layer 12. The first undulation amount 12c can be an average value.

The decorative layer 13 is disposed on the surface of the base layer 12. In the present embodiment, mainly volatile ink is discharged from the discharge nozzle and fixed using the inkjet printer described above. The decorative layer 13 is provided within the formation area of the base layer 12 so as not to protrude outside of the formation area of the base layer 12. The second outer edge 13a of the decorative layer 13 is the outer edge of the formation area of the decorative layer 13, and the first outer edge 12a of the base layer 12 is the outer edge of the formation area of the base layer 12. The second outer edge 13a of the decorative layer 13 is located inward of the first outer edge 12a of the base layer 12. The surface of the decorative layer 13 is a curved surface, such as a hemispherical surface or a dome shape.

The decorative layer 13 contains a particle component. The particle component includes metal particles. The metal particles can be anyone of, or a mixture, of silver, gold, copper, nickel, chromium, platinum, palladium, and alloys thereof, and preferably contain silver. The metal particles can be precipitated by heating a metal complex, or may already be in a particle state at room temperature. The metal particles are nanoparticles, the particle diameters being about 1 to 100 nm, for example. The decorative layer 13 preferably contains a volatile ink component. The ink that forms the decorative layer 13 is more volatile than the ink that forms the base layer 12. The decorative layer 13 can be formed of inkjet ink, and it is also preferable to form the decorative layer 13 by applying ink using an inkjet printer. As an example, a silver metal complex having amine as a ligand can be used. The silver metal complex can be diluted with alcohol to impart flowability thereto. The silver nanoparticles, which were precipitated by heating, fuse with each other through melting, resulting in high surface density and tight interconnection. In addition, the metal particles can be dispersed and applied with a thickness of 0.01 μm or more, preferably 0.02 μm or more, and heated at a prescribed temperature, which causes the metal particles to sinter, forming metallic bonds at the particle interfaces and being integrated to form the decorative layer 13. In particular, nanoparticles of silver or an alloy thereof, and mixtures of silver nanoparticles and other metal nanoparticles, start sintering at a relatively low temperature, such as 100° C., which is suitable.

The thickness of the decorative layer 13 can be constant, or gradually increase from the second outer edge 13a of the decorative layer 13 toward the central portion of the decorative layer 13. The maximum thickness of the decorative layer 13 is preferably 20 nm or more and 80 nm or less. The maximum thickness of the decorative layer 13 is less than the maximum thickness of the base layer 12. The thickness of the decorative layer 13 at the second outer edge 13a is less than the thickness of the outer edge of the covered portion 121 of the base layer 12.

As shown in FIG. 2, a second corrugated portion 13b that undulates in the inward/outward directions is formed on the second outer edge 13a of the decorative layer 13. The second corrugated portion 13b is provided continuously along the second outer edge 13a (outline) of the decorative layer 13. The second corrugated portion 13b is formed by ink droplets that form the decorative layer 13. The second direction has a second undulation amount 13c, which is the amount of undulation in the inward/outward direction. The second undulation amount 13c indicates the degree of jaggedness of the second outer edge 13a. The second corrugated portion 13b can be provided regularly or irregularly along the second outer edge 13a of the decorative layer 13. The second undulation amount 13c may be an average value. The second undulation amount 13c is less than the first undulation amount 12c. The second corrugated portion 13b has small and fine undulations, while the first corrugated portion 12b has larger and coarser undulations than the second corrugated portion 13b. A single intermediate layer, or two or more intermediate layers can be provided between the base layer 12 and the decorative layer 13.

The topcoat layer 14 is composed of a transparent or semi-transparent synthetic resin, such as epoxy, urethane, acrylic, acrylic silicone, or the like. The topcoat layer 14 preferably covers the entire decorative layer 13, and preferably covers the entire base layer 12.

As described above, the peripheral portion 122 of the base layer 12 protrudes outward from the outer edge of the decorative layer 13. As a result, the outer edge, i.e., the outline of the decorative layer 13 is less affected by the outer edge of the peripheral portion 122 of the base layer 12, thereby becoming sharp. The first corrugated portion 12b is larger than the second corrugated portion 13b. As a result, the outer edge of the decorative layer 13 is separated inwardly from the first corrugated portion 12b, so that the outer edge of the decorative layer 13 is less affected by the first corrugated portion 12b, and the outer edge of the decorative layer 13 can be formed to be sharp.

What is claimed is:

1. A decorated article, comprising:
a substrate;
a decorative layer containing a particle component; and
a base layer disposed between the substrate and the decorative layer, and the base layer has a covered portion covered by the decorative layer and a peripheral portion disposed on a peripheral edge of the covered portion.

2. The decorated article according to claim 1, wherein
the decorative layer contains a volatile ink component.

3. The decorated article according to claim 1, wherein
the particle component contains metal particles.

4. The decorated article according to claim 3, wherein
the metal particles contain a silver particle component.

5. The decorated article according to claim 1, wherein
a maximum thickness of the decorative layer is 20 nm or more and 80 nm or less.

6. The decorated article according to claim 1, wherein
a thickness of the base layer is greater than a thickness of the decorative layer.

7. The decorated article according to claim 1, wherein
a maximum thickness of the base layer is 80 μm or more and 150 μm or less.

8. The decorated article according to claim 1, wherein
a maximum thickness of the covered portion is greater than a maximum thickness of the peripheral portion.

9. The decorated article according to claim 1, wherein
the base layer contains a UV-curable resin.

10. The decorated article according to claim 9, wherein
the surface of the base layer is leveled so as to omit edges.

11. The decorated article according to claim 9, wherein
the surface of the peripheral portion is leveled so as to omit edges.

12. A fishing rod, comprising:
a rod body composed of a substrate; and
a three-dimensional decorate portion disposed on the rod body,
the three-dimensional decorate portion having a decorative layer containing a particle component and a base layer disposed between the rod body and the decorative layer,
wherein the base layer having a covered portion covered by the decorative layer and a peripheral portion disposed on a peripheral edge of the covered portion.
